(19) United States
(12) Patent Application Publication
(10) Pub. No.: US 2004/0179271 A1
(43) Pub. Date: Sep. 16, 2004

(54) Electronic correction device for optical distortions in a collimated imaging obtained from a matrix display

(76) Inventors: Jean-Rene Verbeque, Saint-Aubin (FR); Olivier Rols, Pessac (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/483,836

(22) PCT Filed: May 27, 2003
(86) PCT No.: PCT/FR03/01601

(30) Foreign Application Priority Data
May 31, 2002 (FR) 02/06721

(51) Int. Cl. G02B 3/00

(52) U.S. Cl. 359/642

(57) ABSTRACT

The invention relates to an electronic correction device for correcting the optical distortions of an optic for collimating and superposing a collimated view in the case where the display is of matrix type. The principle of the invention is to carry out these corrections at the level of the display by associating with each pixel of the display the same number of pixels of each source-image to be displayed, the addresses of the pixels of the source-images being computed from the addresses of the pixels of the display by applying the distortion function for the optic to them.

The computation of the addresses and of the photometric values of the pixels of the display is carried out in a computation unit comprising in particular a unit for computing addresses and an interpolation unit.

The invention applies essentially to so-called head-up or helmet viewing devices used on civil and military aircraft having matrix devices, in particular liquid crystal matrix devices, as display.

The device applies equally well to monochrome displays as to color displays.

The field of the invention is that of systems for presenting collimated images, and more precisely that of so-called head-up sights or helmet VDUs used on aircraft.

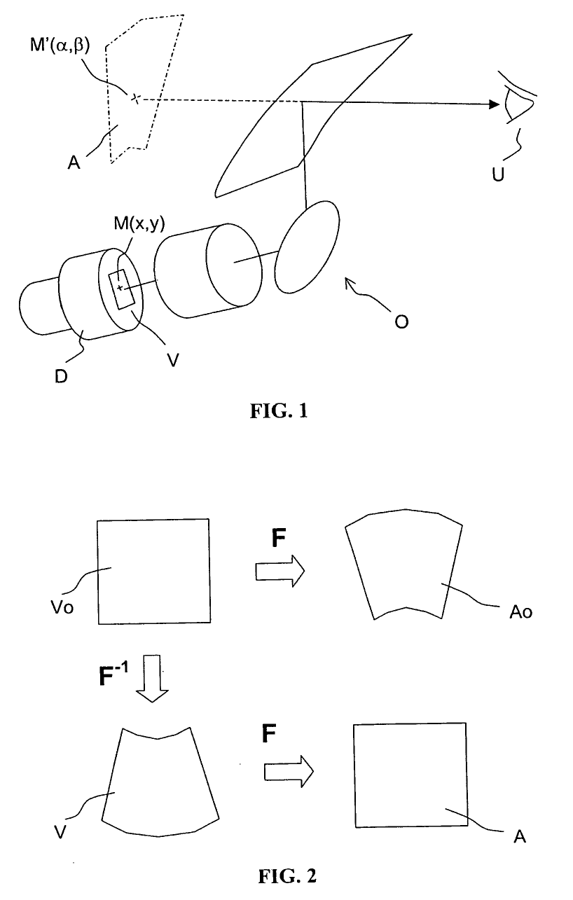

In a general manner, as is indicated diagrammatically on FIG. 1, a system for collimated viewing comprises a display D and a collimation and superposition optic O making it possible to present a user U with the image V provided by the display in the form of an aerial image A collimated at infinity and superposed on the exterior landscape, this image originating from image sources that are not represented in the figure. These systems are especially used on aircraft. There are two main types, on the one hand the so-called head-up systems mounted on the instrument panel in the pilot's field of vision; on the other hand the helmet viewing systems mounted on the pilot's helmet, the optical components used for superposing the images then being placed in front of the pilot's eyes.

These devices are fundamental for aiding piloting and navigation.

The superposed image must be of excellent optical quality to avoid any piloting error and not give rise to considerable eye strain. One of the main technical difficulties in obtaining an image of good quality is the correction of the geometrical distortion introduced on the one hand by the collimation and superposition optic and on the other hand, and to a lesser extent, by the transparent canopy of the aircraft's cockpit in the case of usage as a head-up sight or of the visor of the helmet in the case of usage as a helmet vdu. It is demonstrated that, having regard to the geometrical constraints imposed by the use of the system in a cockpit or on a helmet, the geometrical distortion is considerable and cannot be corrected simply by conventional optical means. The distortion function which maps a point M(x, y) of the two-dimensional image presented by the display to a point M′(α,β), α,β representing the angular coordinates of the point M′, the image of M through the collimated optic, is called F. We have the relations:

ti α=K.F_{α}(x,y) and β=K.F_{β}(x,y)

K being an angular magnification constant.

The upper part of FIG. 2 represents on the left the initial image V₀ provided by the display and on the right the final image Aₒ deformed by the distortion function F of the optic viewed through the collimated optic. To obtain an undeformed image, the method conventionally employed consists in subjecting the image of the display to a distortion inverse to that of the optic, this distortion function being denoted F⁻¹ as is indicated on the left part of FIG. 2 which represents at the top the undeformed initial image V₀ and at the bottom the image V having undergone the inverse deformation F⁻¹.

When this deformed image V is collimated, a distortionless image A is obtained, as is indicated in the lower right quadrant of FIG. 2. Specifically, we have, written symbolically:

A=F(V) hence A=F.F⁻¹(V₀) and finally A=V₀

This method is especially well suited in the case where the image provided by the display is continuous, that is to say the points of which the image is composed are not differentiated. Such is the case in particular with cathode ray tube displays. Whatever distortion function is applied, there is always a point of the screen of the tube corresponding. The distortion function is effected by modifying the parameters for adjusting the horizontal and vertical systems for deflecting the cathode rays. However, cathode ray tubes have a certain number of drawbacks such as bulkiness, implementation of the complex electronics requiring in particular high operating voltages as well as short lifetime. At present, they are gradually being replaced by matrix-type flat displays that do not have the above drawbacks. Several production technologies exist for displays of this type such as, for example, liquid crystal matrices. The use of displays of this type has already been generalized to so-called head-down instrument panel viewing.

Matrix displays are poorly suited to the correction of distortion such as it has been described. A matrix display conventionally comprises P_{u,v} pixels organized as a matrix of R rows and S columns; u, v being integers varying respectively from 1 to R and from 1 to S.

Consider an electronic image Eᵢ originating from a source of images comprising P_{i,j,k} pixels organized as a matrix of Mᵢ rows and N columns; j, k being integers varying respectively from 1 to Mᵢ and from 1 to Nᵢ, with each pixel there being associated a photometric value L_{i, j, k}; to display Eᵢ according to the known method of distortion correction, it is necessary to apply the function F⁻¹ to the pixels P_{i,j, k}. Of course, the application of this function F⁻¹ to the pixel P_{i,j,k} may not correspond, in the general case, exactly to a pixel P_{u,v} of the display. The result of the computation must then necessarily be made to correspond to the pixel of the display that is closest.

This method has three drawbacks:

It does not guarantee that all the pixels of the display will be addressed, thus yielding blind zones in the image of the display. This case is especially noticeable when the images Eᵢ contain a quantity of pixels that is less than or much the same as that of the display.

It does not guarantee that the same number of pixels P_{i,j,k} will be associated with each pixel of the display. This case is especially noticeable when the images Eᵢ contain a quantity of pixels that is greater than that of the display. This may lead to artificial variations in the luminance of the pixels of the display.

It requires the computation of the function F⁻¹ which is not necessarily simple to perform.

It may therefore give rise to the creation of visual artefacts that are difficult for the observer to tolerate.

To alleviate these various drawbacks, the device according to the invention constructs the image of the display by following the inverse process, that is to say by always associating the same number of pixels P_{i,j,k} of each electronic image Eᵢ with each pixel P_{u,v}, the addresses of the pixels P_{i,j,k} being obtained from the computation of F(P_{u,v}). The photometric value L_{u,v} of pixel P_{u,v} is obtained from the photometric values L_{i,j,k} of the P_{i,j,k} Through its very principle, this method does away with the above drawbacks.

More precisely, the subject of the invention is an electronic correction device for correcting the geometrical distortion aberrations of a collimation and superposition optic forming part of a viewing assembly comprising:

a device for generating at least one electronic source-image Eᵢ, i an integer varying between 1 and L;

electronics (C) carrying out the mixing and the correction of the images (Eᵢ) and the generation of a visual image (V) on a display, said image being organized as a matrix of R rows and S columns of pixels (P_{u,v}) with addresses (u,v); u, v being integers varying respectively from 1 to R, and from 1 to S; with each pixel there being associated a photometric value L_{u,v}, this value being dependent on the photometric values L_{i,u,v} arising from each of the electronic images;

said collimation optic (O) providing for the collimation of said visual image so as to form an aerial image (A) intended to be perceived by a user, each pixel of the image (V) having an aerial image (P_{α,β}), (α, β) being the angular coordinates of the points of the aerial image such that a is equal to K.Fᵤ(u,v) and β is equal to K.Fᵥ(u,v); K being an angular magnification constant and Fᵤ(u,v), Fᵥ(u,v) being the representations of the two-dimensional distortion function F of the optical system (O); characterized in that, the electronics (C) comprise a system for correcting the distortion comprising an electronic memory unit making it possible to store the electronic images Eᵢ, an address computation unit and an interpolation and mixing unit such that,

the electronic memory unit organizes each image as a matrix of M rows and N columns of pixels P_{i,j,k} to which the correspond electronic addresses (i,j,k); j, k being integers varying respectively from 1 to Mᵢ, and from 1 to Nᵢ; with each pixel P_{i,j,k} there being associated a photometric value L_{i,j,k};

the unit for computing addresses associates with each address (u,v) the addresses (i,j,k) of the pixels P_{i,j,k} stored in the electronic memory, said addresses neighboring the computed points (i, jᵣ, kᵣ), jᵣ, kᵣ being real numbers obtained by computing Kᵢ′.Fᵤ(u,v) and Kᵢ′.Fᵥ(u,v); Kᵢ′ being a normalization constant associated with each electronic image Eᵢ such that, for any i, jᵣ is less than Mᵢ and kᵣ is less than Nᵢ.

the interpolation and mixing unit computes the photometric value L_{i,u,v}, the contribution of each electronic image to the value L_{u,v} from the photometric values L_{i,j,k} of said pixels with addresses (i,j,k) provided by the address computation unit.

In a preferred mode, for each image Eᵢ, the pixels used by the interpolation unit for the computation of the photometric value L_{i,u,v} are at least the four pixels with addresses referenced (i, jₑ, kₑ), (i, jₑ+¹, kₑ), (i, jₑ, kₑ+1) and (i, jₑ+1, k,+1) with (jₑ, kₑ) the integer parts of the numbers (jᵣ, kᵣ), L_{i,u,v} being a function of at least the four values L_{i,je,ke}, L_{i,je+1,ke}, Lᵢ, je, ke+1 and L_{i, je+1, ke+1}. In order to carry out the computation of the photometric value it has to take account of pixels other than the square of pixels surrounding the computed point. In this case, their contribution to the photometric value L_{i,u,v} is then weighted as a function of their distance from the point of address (i, jᵣ, kᵣ). However, the gain afforded remains marginal at the cost of a noticeable increase in the number of necessary computations.

There are various possible methods of obtaining the photometric value L_{i,u,v}. The simplest method, requiring the minimum of computations is that the photometric value L_{i,u,v} be proportional to the sum of the products L_{i,je,ke}.(1+jₑ−jᵣ).(1+kₑ−kᵣ); L_{i,je+1,ke+1}.(jᵣ−jₑ). (kᵣ−kₑ); L_{i,je+1,ke}.(jᵣ−jₑ).(1+kₑ−kᵣ) and L_{i,je ke+1}. (1+jₑ−jᵣ).(kᵣ−kₑ).

The normalization constants Kᵢ′ are computed in such a way that all the pixels of the display have corresponding counterparts in each electronic image. Advantageously, it is beneficial to be able to vary these constants between a minimum value and their maximum value. One then obtains an electronic zoom effect, part of the initial electronic images being only represented magnified over the entire area of the display.

Advantageously, the electronic correction can be undertaken in an electronic component comprising matrices of logic gates (AND or OR). These components may be of nonprogrammable type such as, for example, ASICs (Application Specific Integrated Circuit) or of programmable type such as, for example, FPGAs (Field Programmable Gate Array) or EPLDs (Erasable Programmable Logic Device). These electronic components are widely used in professional electronics and in particular for aeronautical applications.

Conventionally, the optical distortion function is approximated by a polynomial of degree n in (u,v), in this case, the distortion correction system is obtained by the use of digital differential analyzers (DDA).

Conventionally, the collimated viewing systems used on aircraft are monochrome for reasons:

of simplicity of production of the system (use of monochrome cathode ray tubes and of highly wavelength selective high-efficiency refractive components),

of absence of polychrome source-images (the images originating from light intensification systems or from thermal cameras are monochrome)

of ergonomics. These images are presented superposed on the exterior landscape. To improve the readability of the symbology information presented, it is often beneficial to use a single color.

However, advances in techniques and especially the use of matrix displays according to the invention are allowing the use and the presentation of colored images which, when used at night in particular may have certain ergonomic advantages. The device is also suitable for correcting distortion in colored images. In this case, the display being polychromatic consisting of color pixels, each pixel being composed of a trio of three colored subpixels, each corresponding to a primary color and the electronic source images also being polychrome each consisting of color pixels, each pixel also being composed of a trio of three colored subpixels, each corresponding to a primary color; the computations performed by the address computation unit and the interpolation unit in order to determine the photometric values of each colored pixel of the display are carried out respectively for each type of subpixel of the source-images of like color.

The invention will be better understood and other advantages will become apparent on reading the description which follows given by way of nonlimiting example and by virtue of the appended drawings among which:

FIG. 1 represents a general view of a viewing device presenting collimated images in the particular case of a head-up sight.

FIG. 2 represents the principle of distortion correction according to the known art.

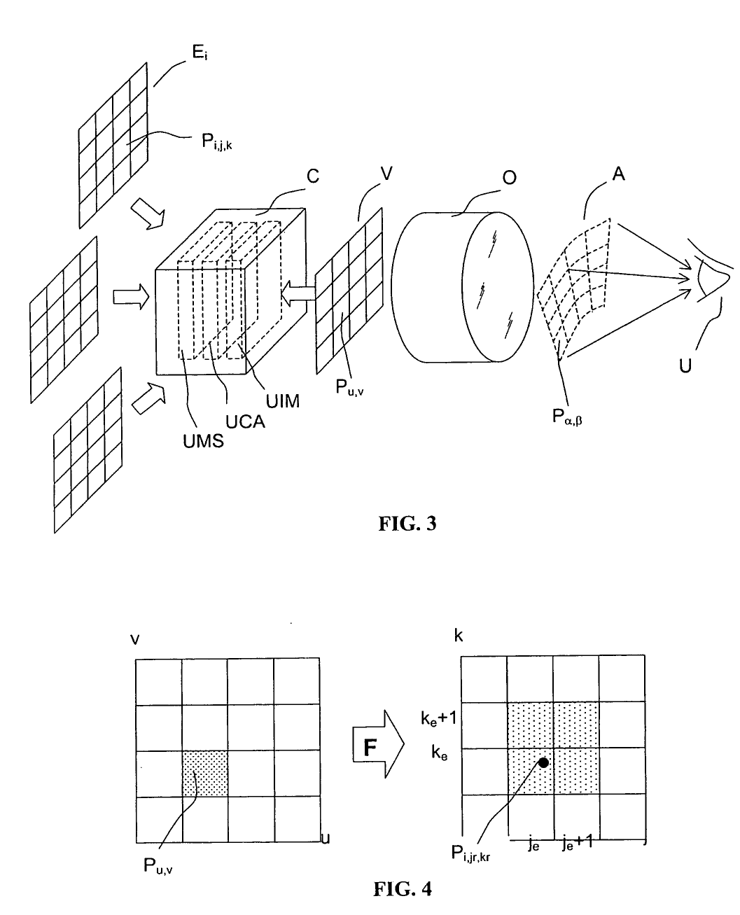

FIG. 3 represents the principle of correction according to the invention.

FIG. 4 represents the principle of determining those pixels of the electronic images that are picked to determine the luminance value of the pixels of the display.

The images Eᵢ reaching a collimated viewing system may then have several origins. They may originate:

from video camera systems mounted on the aircraft itself, these systems working in the visible or the infrared or these systems being light intensifier systems;

from generators of synthetic images originating in particular from generators of cartographic images or from symbology generators.

Whatever their origin, it is always possible to store these images in a matrix electronic memory UMS such that, each image is organized as a matrix of Mᵢrows and Nᵢ columns of pixels P_{i,j,k} to which there correspond electronic addresses (i,j,k); j, k being integers varying respectively from 1 to Mᵢ and from 1 to Nᵢ; with each pixel P_{i j,k} there being associated a photometric value L_{i,j,k}.

Consider a collimation system exhibiting a distortion function F, this function is a function of two variables such that with two geometrical parameters (x,y) there are associated two other geometrical parameters (u,v) such that u=Fᵤ(x,y) and v=Fᵥ(x,y). In order for the aerial image presented to the pilot to be distortionless, it is necessary to apply the inverse distortion correction F⁻¹ to the original electronic image before forwarding it to the display. Reciprocally, the electronic image is therefore obtained from the image of the display by applying said function F to it. We thus have the following symbolic relation:

E_{i,j,k}=F(A_{u,v})

Electronically, if the image of the display is organized as a matrix of R rows and S columns of pixels P_{u,v} with addresses (u,v); u, v being integers varying respectively from 1 to R and from 1 to S, then to determine the pixels P_{i,j,k} of the electronic images, it is sufficient for the electronic unit to comprise a unit for computing addresses UCA such that said unit associates the addresses (i,j,k) of the pixels P_{i,j,k} stored in the electronic memory with each address (u,v), said addresses neighboring the computed points (i, jᵣ, kᵣ), jᵣ, kᵣ being real numbers obtained by computing Kᵢ′.Fᵤ(u,v) and Kᵢ′.Fᵥ(u,v); Kᵢ′ being a normalization constant associated with each electronic image Eᵢ such that, for every i, jᵣ is less than Mᵢ and kᵣ is less than Nᵢ.

The constants Kᵢ′ may be obtained by several methods. It is, by way of example, possible to compute Fᵤ(u,v) and Fᵥ(u,v) for a limited number of pixels belonging to the contour of the image of the display. The maximum possible addresses are thus determined for these points. It is then sufficient to compute the constants Kᵢ′ such that these maximum addresses are much lower than (Mᵢ, Nᵢ). It is possible, in a particular mode of the invention, to give these constants lower values so as to obtain zoom effects on the image of the display.

The geometrical distortion functions introduced by the optic are functions of physical origin. They are in general continuous and differentiable. The function F can therefore be approximated with good accuracy by a polynomial function of degree n. We then have:

Fᵤ(u,v)=Fᵤ(u₀,v₀)+δFᵤ(u₀,v₀)/δu.u₀+δFᵤ(u₀,v₀)/δv.v₀+. . . +δⁿFᵤ(u₀v₀)/δvⁿ.V₀ⁿ

with (u₀,v₀) original address and δⁿFᵥ(u₀,v₀)/δvⁿ the partial derivative of degree n of the function Fᵤ with respect to v about the address (u₀,v₀).

and Fᵥ(u,v)=Fᵥ(u₀,v₀)+δFᵥ(u₀,v₀)/δu.u₀+δFᵥ(u₀,v₀)/δv.v₀+. . . +δFᵥ(u₀,v₀)/δvⁿ.v₀ⁿ

with (u₀,v₀) the original address and δⁿFᵥ(u₀,v₀)/δvⁿ the partial derivative of degree n of the function Fᵥ with respect to v about the address (u₀,v₀).

Two possible typical cases exist:

If the function F is a known and differentiable mathematical function, then the computation of the partial derivatives is immediate.

If the function F has no known mathematical equation, this being the case most often encountered in practice, then the determination of the partial derivatives is effected as follows:

a matrix of points (u,v) is created, each corresponding to a point (x,y) after mapping by the function F. These points may either be simulated using optical computation software, or measured on the sight itself by generating a grid of points on the display;

the coefficients of the polynomials are then obtained by matrix inversion. Several methods are possible. It is possible to use for example the method of Choleski that makes it possible to minimize the error over the set of values of the matrix. This method is commonly used in cartographics.

The use of a polynomial function in place of the true function allows a considerable simplification in the setup of the computations performed by the address computation unit. This computation is then carried out by an electronic assembly consisting mainly of a double DDA (Digital Differential Analyzer) that carries out the polynomial approximation for each of the two coordinates u and v. Each DDA consists of a certain number of cascaded adders/accumulators each taking charge of the computation of each term of the polynomial. The initialization values and the increments that are necessary are provided by an ancillary microprocessor. It should be noted that these values may be readily modified, for example to obtain perfect harmonization of the sight on aircraft. Allowance may thus readily be made for the distortions due to a specific canopy or to a different sight positioning, in the case for example of two-seater aircraft using the same sight at two different locations in the cockpit.

The frequency of computation of these DDAs mimicks that of the scanning of the image of the display, the computations having to be performed in real time so as not to create any delay between the collimated image and the actually perceived image of the landscape which may evolve very rapidly as a function of the movements of the aircraft.

In order to avoid spurious visual artefacts, it is beneficial to choose the sizes of the electronic memory storage units different from that or the display. That is to say each pair (Mi,Ni) should be significantly different from the pair (R,S).

The address (i, jᵣ, kᵣ) corresponding to the address (u,v) of the pixel P_{u,v} being known, the interpolation and mixing unit UIM computes the photometric values L_{i,j,k}. To carry out this computation use is made of the photometric values L_{i,j,k} of the pixels whose address is closest to the computed address (i, jᵣ, kᵣ). Each of these values being weighted by a weighting coefficient depending essentially on the distance from the address of the pixel to the computed address. In the simplest and most general case, use is made of four pixels grouped into a square such that their respective addresses are: (i, jₑ, kₑ),(i, jₑ+1, kₑ), (i, jₑ, kₑ+1) and (i, jₑ+1, kₑ+1) with (jₑ, kₑ) integer parts of the numbers (jᵣ, kᵣ).

In this case, the computation of the photometric value L_{i,u,v} may be effected simply. By way of example, it is possible to use the following function:

L_{i,u,v}=λᵢ.[L_{i,je,ke}.(1+jₑ−jᵣ).(1+kₑ−kᵣ)+L_{i,je+1,ke+1}.(jᵣ−jₑ).(kᵣ−kₑ)+L_{i,je+1,ke}.(jᵣ−jₑ).(1+kₑ−kᵣ)+L_{i,je ke+1}.(1+jₑ−jᵣ).(kᵣ−kₑ)]

with λᵢ the normalization factor dependent on each image Eᵢ.

The global photometric value L_{i,u,v} of each point of the display is equal to the contribution of each of the photometric values L_{i,u,v}. In general we write:

L_{i,u,v=Σλ}ᵢ. L_{i,u,v}

By modulating the various normalization factors λi, it is thus possible to modulate the contributions of each electronic image to the final image. It is thus possible to depict just a single image or to mix several images so as to depict in particular symbology information on a real image or a synthetic cartography image.

This interpolation and mixing unit as well as the address computation unit may be implemented in electronic components comprising matrices of logic gates (AND or OR). These components may be of nonprogrammable type such as, for example, ASICs (Application Specific Integrated Circuit); in this case, the information is burnt in during the production of the circuit. These components may also be programmable such as, for example, FPGAs (Field Programmable Gate Array) or EPLDs (Erasable Programmable Logic Device). These components are commonly used for professional or airborne electronic applications.

The above computations are done in the case of a monochrome display and of likewise monochrome image sources, this covering the major part of contemporary applications. However, the invention also applies to the case of polychrome displays and polychrome image sources. Specifically, a polychrome image always breaks down into three monochrome images of different color. It is then sufficient to do the computations for each monochrome image. More precisely, the display being polychromatic consisting of color pixels, each pixel being composed of a trio of three colored subpixels, each corresponding to a primary color and the electronic source images also being polychrome each consisting of color pixels, each pixel also being composed of a trio of three colored subpixels, each corresponding to a primary color; the computations performed by the address computation unit and the interpolation unit in order to determine the photometric values of each colored pixel of the display are carried out respectively for each type of subpixel of the display and for each type of subpixel of the source-images of like color.

1. An electronic correction device for correcting the geometrical distortion aberrations of a collimation and superposition optic (O) forming part of a viewing assembly comprising:
a device for generating at least one electronic source-image Eᵢ, i an integer varying between 1 and L;
electronics (C) carrying out the mixing and the correction of the images (Eᵢ) and the generation of a visual image (V) on a display, said image being organized as a matrix of R rows and S columns of pixels (P_{u,v}) with addresses (u,v); u, v being integers varying respectively from 1 to R, and from 1 to S; with each pixel there being associated a photometric value L_{u,v}, this value being dependent on the photometric values L_{i,u,v} arising from each of the electronic images;
said collimation optic (O) providing for the collimation of said visual image so as to form an aerial image (A) intended to be perceived by a user, each pixel of the image (V) having an aerial image (P_{αβ}), (α, β) being the angular coordinates of the points of the aerial image such that α is equal to K.Fᵤ(u,v) and β is equal to K.Fᵥ(u,v); K being an angular magnification constant and Fᵤ(u,v), Fᵥ(u,v) being the representations of the two-dimensional distortion function F of the optical system (O); characterized in that, the distortion function F is approximated by a polynomial function of degree n and that the electronics (C) comprise a system for correcting said distortion comprising an electronic memory unit (UMS) making it possible to store the electronic images (Eᵢ), an address computation unit (UCA) and an interpolation and mixing unit (UIM) such that,
the electronic memory unit (UMS) organizes each image (Eᵢ) as a matrix of M rows and N columns of pixels (P_{i,j,k}) to which there correspond electronic addresses (i,j,k); j, k being integers varying respectively from 1 to Mᵢ, and from 1 to Nᵢ; with each pixel (P_{i,j,k}) there being associated a photometric value L_{i,j,k};
the unit for computing addresses associates with each address (u,v) the addresses (i,j,k) of the pixels (P_{i,j,k}) stored in the electronic memory, said addresses neighboring the computed points (i, jᵣ, kᵣ), jᵣ, kᵣ being real numbers obtained by computing Kᵢ′.Fᵤ(u,v) and K_{i′.F}ᵥ(u,v); Kᵢ′ being a normalization constant associated with each electronic image (Eᵢ) such that, for any i, jᵣ is less than Mᵢ and kᵣ is less than Nᵢ.
the interpolation and mixing unit (UIM) computes the photometric value L_{i,u,v}, the contribution of each electronic image to the value L_{u,v} from the photometric values L_{i,j,k} of said pixels with addresses (i,j,k) provided by the address computation unit.

2. The electronic correction device as claimed in claim 1, characterized in that, for each image (Eᵢ), the pixels used by the interpolation and mixing unit for the computation of the photometric value L_{i,u,v} are at least the four pixels with addresses referenced (i, jₑ, kₑ), (i, jₑ+1, kₑ), (i, jₑ, kₑ+1) and (i, jₑ+1, kₑ+1) with (jₑ, kₑ) the integer parts of the numbers (jᵣ, kᵣ), L_{i,u,v} being a function of at least the four values L_{i,je,ke}, L_{i,je,+1,ke}, L_{i,je,ke+1} and L_{i, je+1, ke+1}.

3. The electronic correction device as claimed in claim 2, characterized in that the photometric value L_{i,u,v} is proportional to the sum of the products L_{i,je,ke}. (1+jₑ−jᵣ).(1+kₑ−kᵣ); L_{i,je+1,ke+1}. (jᵣ−jₑ).(kᵣ−kₑ); L_{i,je+1,ke}. (jᵣ₋ⱼₑ). (1+kₑ−kᵣ) and L_{i,je ke+1}. (1+jₑ−jᵣ).(kᵣ−kₑ).

4. The electronic correction device as claimed in claim 1, characterized in that the normalization constant Kᵢ′ can be tailored in such a way as to obtain electronic zoom effects on the final image (V).

5. The electronic correction device as claimed in claims 1 to 3, characterized in that the electronics (C) comprise a nonprogrammable electronic component of ASIC type (Application Specific Integrated Circuit) or a programmable electronic component of FPGA type (Field Programmable Gate Array) or EPLD type (Erasable Programmable Logic Device).

6. The electronic correction device as claimed in claim 4, characterized in that the distortion correction system is obtained by the use of digital differential analyzers (DDA).

7. The electronic correction device as claimed in any one of the preceding claims, characterized in that the display being polychromatic consisting of color pixels, each pixel being composed of a trio of three colored subpixels, each corresponding to a primary color and the electronic source images also being polychrome each consisting of color pixels, each pixel also being composed of a trio of three colored subpixels, each corresponding to a primary color; the computations performed by the address computation unit and the interpolation unit in order to determine the photometric values of each colored pixel of the display are carried out respectively for each type of subpixel of the display and for each type of subpixel of the source-images of like color.
